(19) United States
(12) Patent Application Publication
(10) Pub. No.: US 2010/0333130 A1
(43) Pub. Date: Dec. 30, 2010

(54) SYSTEMS AND METHODS FOR VERIFYING RECEIPT OF BROADCAST TRANSMISSIONS PRIOR TO BILLING

(75) Inventor: TODD B. PETERSON, Carlsbad, CA (US)

Correspondence Address: McDermott Will & Emery LLP, 600 13th Street, NW, Washington, DC, 20005-3096, US

(73) Assignee: QUALCOMM Incorporated, San Diego, CA (US)

(21) Appl. No.: 12/491,974

(22) Filed: Jun. 25, 2009

(51) Int. Cl. H04N 7/167; H04L 9/08

(52) U.S. Cl. 725/31; 380/279; 380/211

(57) ABSTRACT

Methods and systems allow mobile TV broadcast service providers to verify reception of broadcast transmissions to mobile devices prior to billing for such services. When a request for a broadcast service is received, a mobile TV broadcast service provider may transmit a first long term decryption key message including a restricted access key to enable viewing of a broadcast for a limited time. A prompt on the mobile device may ask the user to verify satisfactory reception of the broadcast. If the user indicates satisfactory reception, a satisfactory reception verification message may be sent to the mobile TV broadcast service provider, which may then send a second long term decryption key message enabling the user's mobile device to receive the requested program. The user's account may then be billed for the broadcast.

### BACKGROUND

Wireless communication technologies have seen explosive growth over the past few years. This growth has been fueled by wireless services providing freedom of movement to the mobile public, and cutting the tether to hard-wired communication systems. In addition, increasing quality and speed of voice and data communications over the wireless medium has attracted additional users. As a result of these service enhancements, wireless services are expected to continue to grow rapidly.

A recent addition to wireless communication technologies has been the ability of broadcast television to mobile users. Mobile broadcast users can view mobile editions of news, entertainment, sports, business, and other television programming using their cell phone or other wireless devices. These broadcast systems have seen significant increase in usage and availability worldwide. At present, users of mobile television and broadcast systems pay fees to receive program content. These fees vary with the service provider and level of service chosen.

### SUMMARY

The various embodiments provide methods and systems for verifying the successful transmission of mobile broadcast content to a mobile device. In the various embodiments, when customers order a pay-per-view type service from a mobile broadcast service provider, the mobile broadcast service provider may provide the customer a temporary decryption key to enable the customer's mobile device to decode and view the broadcast program for a limited period of time, or view another program to confirm reception. After the temporary decryption key is provided, the customer may be prompted by a message on the customer's mobile device to confirm whether the broadcast is being successfully received. If the customer responds affirmatively to the prompt by sending a verification message via a unicast communication network separate from the broadcast network, the mobile broadcast service provider may bill the customer for the broadcast service and transmit a decryption key valid for the duration of the purchased broadcast service. However, if the customer does not verify the receipt of the broadcast transmission, either by sending a message via the unicast network indicating that the broadcast is not being received or by not responding to the prompt within a certain time period, the mobile broadcast service provider will not bill the customer for the requested service. The temporary nature of the decryption key originally provided to the customer prevents the customer from viewing the content without paying for it. Optionally the mobile broadcast service provider may send the customer's mobile device a marketing message indicating that the customer's account will not be billed for requested broadcast service and inviting the customer to resend a service request message or call customer service to receive help with the broadcast program.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a network component diagram illustrating participants involved in mobile broadcast transmissions.

FIGS. 2A and 2B are process flow diagrams of a method for verifying successful reception of a mobile broadcast transmission before billing a customer or the service.

FIG. 3 is a message flow diagram useful in conjunction with the method illustrated in FIGS. 2A and 2B.

FIG. 4 is a process flow diagram of a method for verifying access to encrypted broadcast content.

FIGS. 5 and 6 are frontal views of a mobile device.

FIG. 7 is a system block diagram of a mobile device.

FIG. 8 is a system block diagram of a server device.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “mobile device” and “computing device” refer to any one or all of telephone devices, mobile devices, cellular telephones, personal data assistants (PDA's), palm-top computers, wireless electronic mail receivers and cellular telephone receivers (e.g., the Blackberry® and Treo® devices), multimedia Internet enabled cellular telephones (e.g., the Blackberry Storm®), Global Positioning System (GPS) receivers and similar personal electronic devices which include a programmable processor and are configured to receive mobile broadcast transmissions. The term may also encompass personal computers, such as a laptop computer or a desktop computer, with wired and wireless network transceiver circuits when used in the description of the various aspects which may also be implemented on or with personal computers.

The term “unicast” is used herein to refer to the transmission of data, such as voice, between two device, typically using an addressing scheme that individually identifies at least one of the devices. An example of unicast communication is a cell phone call where in a cellular network transmits data to a particular cell phone using a unique identifier associated with the cell phone. Other examples of unicast transmissions include short message service (SMS), multimedia message service (MMS), and electronic mail messages.

The word “broadcast” is used herein to mean the one-way, typically non-addresses, transmission of data intended to be received by any receiving device within range of the transmission that is adapted to receive and decode the signal. Examples of broadcast messages include over-the-air television broadcasts, and mobile television broadcasts.

The word “content providers” is used herein to refer to companies which provide video, website and other data for broadcast over a mobile television system. The term “mobile broadcast service providers” is used herein to refer to those entities which operate mobile broadcast networks and sell mobile broadcast program access to customers.

Table 1 includes an alphabetical list of abbreviations with their related meanings that are used herein:

TABLE 1
Table of Abbreviations

| Abbreviations | Meaning |
|---|---|
| LTKM | Long Term Key Message |
| MMS | Multimedia Message Service |
| PPV | Pay-Per-View |
| SMS | Short Message Service |
| STKM | Short Term Key Message |
| TEK | Traffic Encryption Key |
| MFSO | Media Flow Service Operator |

As the demand for mobile broadcast services rise, telecommunication and mobile broadcast network service providers are facing problems and challenges related to customer service and customer satisfaction. For example, one problem that mobile broadcast service providers may face involves charging customers for purchased pay-per-view (PPV) programs. Unlike cable television which has a reliable connection to fixed television receivers, there is no guarantee that any given mobile device is able to receive a broadcast transmission. An inability to view the content may be due to a number of factors, including lack of service coverage in the vicinity of the mobile device, local interference with a mobile broadcast signal, or some incompatibility between the broadcasted data and the mobile device 30. Other example of factors which lead to an inability to receive broadcasts include, the user moving out of range of the transmitter, or behind some obstruction, such as a building, or simply just entering a “dead zone.”

Since mobile broadcast services are broadcast transmissions, and thus one-way communications, mobile broadcast service providers have no mechanism for determining whether a particular broadcast has been received by a particular mobile device. If mobile broadcast service providers bill customers for broadcasts they did not receive a customer relation problem can develop. Not only will such bills reminded the customer that they did not receive the requested broadcast service, the mobile broadcast service providers must refund the amount related to the program that was requested but not received. This may cause customer frustration with the mobile broadcast service provider, erode customer confidence and decrease customer satisfaction. On the other side of the coin, because mobile broadcast service providers do not have the ability to determine whether a transmission is successfully received by any given customer, mobile broadcast service providers must accept as valid every refund request claiming that the purchased service was not received. The inability of mobile broadcast service providers to confirm whether a broadcast transmission is received may be taken advantage of by unscrupulous customers, which may lead to reduced profitability.

One method to solve the foregoing problem is for the mobile broadcast service provider to issue a temporary decryption key when a mobile device user orders a pay-per-view broadcast program. The temporary decryption key enables the customer's mobile device to decrypt the broadcast program for a limited duration. The customer's mobile device displays a prompt requesting the user to indicate whether the ordered broadcast transmission is being successfully received. If the customer transmits an affirmative response to the mobile broadcast service provider, using for sample a separate unicast communication network, a longer-term decryption key may be sent to the customer's mobile device enabling the customer to receive the entire requested broadcast program. At this point the customer may be billed for the requested service. If the customer transmits a negative response, or fails to respond at all, no long term key is transmitted and the customer will not be billed for the requested service.

By giving the customer an opportunity to confirm that the broadcast is being successfully received before billing the customer, mobile broadcast service providers avoid the problem of billing customers for services they did not receive. Additionally, mobile broadcast service providers receive an affirmative confirmation that the user received at least a portion of the broadcast, and therefore has a basis for contesting refund requests. The temporary decryption key may be valid for a limited time, such as two to five minutes, so that the entire broadcast content is not transmitted for free.

If a customer indicates that the broadcast transmission cannot be received, the mobile broadcast service provider may take steps to rectify the technical problem associated with the broadcast reception, as well as address the potential customer relations problem due to the inability to deliver a requested service. For example, the mobile broadcast provider mobile broadcast service provider may send a second temporary decryption key to determine whether this will solve the reception problem. Also, the mobile broadcast service provider may send messages to the customer's mobile device suggesting steps that the customer may take to receive the program, such as moving to an area of better signal quality (e.g., moving close to a window within a building). Also, the mobile broadcast service provider may send messages apologizing for service problems.

A number of different mobile broadcast television services and broadcast standards are available or contemplated in the future, all of which may implement and benefit from the various embodiments. Such services and standards include Open Mobile Alliance Mobile Broadcast Services Enabler Suite (OMA BCAST), MediaFLO, Digital Video Broadcast IP Datacasting (DVB-IPDC), and China Multimedia Mobile Broadcasting (CMMB).

Typically, mobile broadcast transmissions are encrypted so that the access to programming can be sold on a subscription or pay-per-view basis. A variety of mechanisms may be used to link decryption keys to subscription purchases. Typically, mobile broadcast services utilize unicast communication networks, such as a customer's cellular telephone data service, to communicate subscription messages to/from particular customer mobile devices, and a separate broadcast network to broadcast the mobile television programming to all mobile devices. In overview, a mobile broadcast service provider can transmit messages which include information that enables a mobile device to generate the decryption keys needed to receive a particular broadcast. Decryption keys may be configured to expire after a predetermined amount of time to enable pay-per-view type services, as well as limit the economic impact of decryption keys falling into the public domain. Additionally, the messages providing decryption keys may include service limitation parameters that may be used to limit received broadcast services to particular programs, channels, or other market segmentations.

By way of example, the OMA BCAST standard uses a long-term key message (LTKM) that is transmitted to mobile devices via a unicast network to provide a restricted access key. The restricted access key is used by the mobile device to decrypt a Traffic Encryption Keys (TEKs) contained within Short Term Key Messages (STKMs) which are broadcast regularly over the mobile broadcast network. When decrypted, each TEK enables a mobile device to decrypt an encrypted broadcast content stream for a short period of time (e.g. two minutes). When a TEK expires, access to the encrypted broadcast content will terminate unless a new TEK is obtained. To enable customers to view entire programs, STKM messages are broadcast on a regular basis so that new TEKs can be obtained by decrypting a portion of the STKM using the long-term key obtained from the LTKM.

The following description of system and methods use terminology associated with the Open Mobile Alliance (OMA) BCAST standard. It is to be noted that while generally similar, other mobile broadcast standards may use different terminology and methods to accomplish similar goals. Those of ordinary skill in the art are generally aware of the similarities and differences between the various mobile broadcast standards and will be able to apply the general concepts taught herein to a variety of other standards. For example, DVB-IPDC uses Key Management Messages (KMMs) in a manner similar to the LTKM of the OMA BCAST standard, Key Stream Messages (KSM) in a manner similar to the STKM of the OMA BCAST standard, and TEKs in a manner similar to the TEKs of the OMA BCAST standard. Similarly, MediaFLO and CMMB use Encryption Management Messages (EMMs) in a manner similar to the LTKM of the OMA BCAST standard, Encryption Codeword Messages (ECM) in a manner similar to the STKM of the OMA BCAST standard, and Codewords (CW) in a manner similar to the TEKs of the OMA BCAST standard. Thus, the following descriptions are provided as an example, and are not intended to limit the scope of the embodiments or the claims to the OMA BCAST standard. For ease of reference, longer term rights management messages will be referred to herein as long term decryption key messages or LTKM, the shorter term decryption key delivery messages will be referred to herein as a short term decryption key messages or STKM, and the decryption key used to decrypt encrypted broadcast content will be referred to herein as the content decryption key or TEK.

The various embodiments may be implemented within the OMA BCAST technologies, for example, by transmitting to customers a temporary LTKM that will expire within a limited period of time. The temporary LTKM may be transmitted by the mobile broadcast service provider in response to receiving a customer purchase request for a particular program or pay-per-view content. When the temporary LTKM is received, the mobile device may use that message content to decrypt portions of STKM messages to obtain a TEK to view the requested broadcast transmission. A message may then be displayed on the mobile device display prompting the customer to verify that the requested program is being received satisfactorily. The information or code necessary to cause the mobile device to generate this prompt may be included within the temporary LTKM or within programs stored in the mobile device which are triggered by receipt of a temporary LTKM. If the requested program is being successfully received, the customer may indicate satisfaction by pressing a menu key, such as pressing a virtual key linked to a “YES” menu item as is typical in many mobile device user interfaces. Similarly, if the requested program is not being received satisfactorily, the customer may indicate dissatisfaction by pressing a different menu key. In response to activation of a menu key the mobile device may generate and transmit a verification message to the mobile broadcast service provider via the unicast communication network. This verification message may indicate satisfactory or unsatisfactory reception of the broadcast signal. Upon receiving a satisfactory reception verification message (i.e. a message confirming successful receipt of the requested broadcast), the mobile broadcast service provider may send a second LTKM including an unrestricted access key that may be used to decrypt the TEKs carried within the STKM stream so that the desired program can be viewed in its entirety. The mobile broadcast service provider may also bill the user's account upon sending the second LTKM. Alternatively, instead of sending a second LTKM with an unrestricted access key, the mobile broadcast service provider may transmit a revising message to amend the first LTKM to change its restriction rules and convert them to permit unrestricted access. If an unsatisfactory reception verification message or no message is received from the user's mobile device, the mobile broadcast service provider may refrain from billing the user for the requested broadcast transmission. Once the temporary LTKM expires, the customer will be unable to view the requested program.

The various embodiment systems and methods described herein assist mobile broadcast service providers with avoiding a potential customer service issue by not billing their customers for programs which they could not receive. Receiving a satisfactory reception verification message before billing customers, enables mobile broadcast service providers to contest requests for refunds in which the customer alleges that the program could not be received.

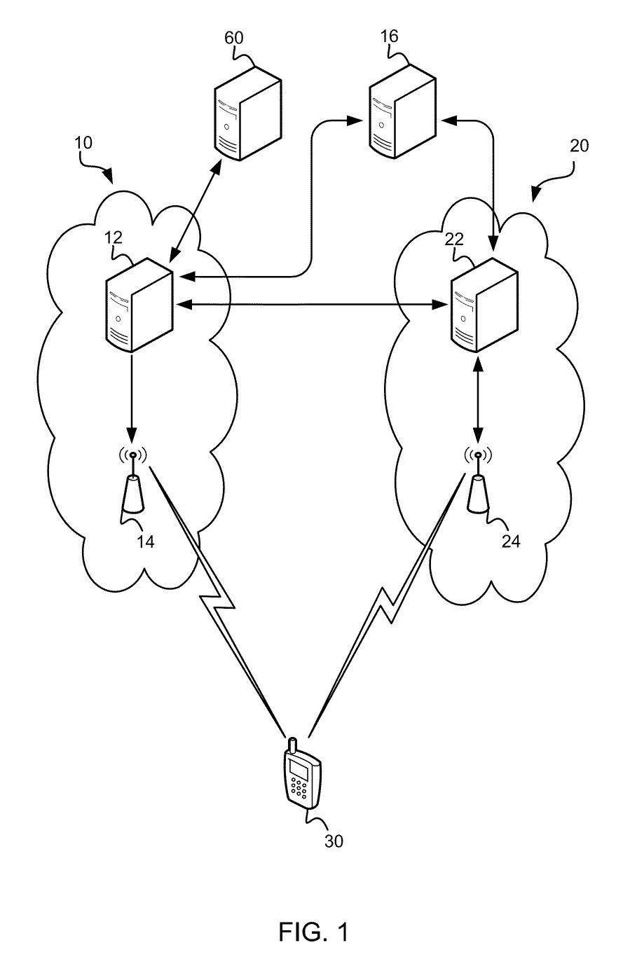

FIG. 1 is a communication system diagram of a mobile broadcast system. A mobile broadcasts service provider 12 operates a mobile TV broadcast network 10 that transmits mobile broadcast content to mobile devices 30 using one or more broadcast transmitters 14. The mobile broadcast service provider 12 may contract with one or more content providers 60 for content and data, i.e. programming. The mobile broadcast service providers 12 may also associate with wireless service providers 22. The wireless service provider 22 provides a communication network 20 that facilitates unicast communications with mobile device 30 users via one or more base stations 24.

The mobile broadcast service provider 12 and/or the wireless service provider 22 may also contract with a financial manager 16 to provide billing and collection services. A mobile broadcast service provider 12 and/or wireless service provider 22 may collect and store customer information related to use of service and provide that information to the financial manager 16. The financial manager 16 may bill the customer according to instructions received from the wireless service provider 22 and/or the mobile broadcast service provider 12. For example, when a program is broadcast to a customer, the transmission information may be collected and sent to the financial manager 16 which in turn may charge the customer's account for the program.

When a customer desires to receive a broadcast program, a request for the service may be sent from the customer's mobile device 30. The request for service may be transmitted from the mobile device 30 to a base station 24 in the unicast network 20. The received request may then be sent by the wireless network provider 22 to the mobile broadcast service provider 12 either via direct communication or via the Internet (not shown). Upon receipt of the service request message, the mobile broadcast service provider 12 may communicate with the requesting mobile device 30 by sending a message, such as an LTKM through the unicast network 20. The mobile broadcast service provider 12 also broadcasts encrypted content streams along with STKM streams directly to the mobile devices 30 using the mobile TV broadcast network 10 and via the broadcast transmitter 14.

A wireless service provider 22, such as Verizon®, may contract with Qualcomm's Media FLO Service Operator (MFSO) to provide mobile broadcast network 10 services to its mobile TV broadcast customers. Verizon® may also provider the unicast network 20 that provides point-to-point communications between mobile devices 30 and the mobile TV broadcast network 10. Accordingly, a Verizon® customer may order mobile TV programs using their mobile devices 30. The order may be received by the unicast network 20 and the wireless service provider 22 (i.e. Verizon®). The order may then be transmitted to the mobile broadcast service provider 12 (e.g., the MFSO). In response, the mobile broadcast service provider 12 may transmit a first long term decryption key message, such as a first LTKM, to the requesting mobile devices 30 which includes the authorization and decryption key needed to gain access to the requested program. The requesting mobile devices 30 use the received decryption key to decrypt traffic encryption keys (TEKs) within short term decryption key messages (e.g., STKMs) and then use those TEKs to decrypt the requested program which is broadcasted to all mobile devices 30 by the mobile TV broadcast network 10. Customer verification of satisfactory reception may be communicated by the wireless service provider 22 to the mobile broadcast service provider 12. In response, the mobile broadcast service provider 12 may send a second long term decryption key message, such as a second LTKM, which provides the information the mobile device 30 needs to receive the entire requested program. The mobile broadcast service provider or the wireless service provider 22 may also transmit billing information related to the customer's orders or subscription to the financial manager 16. The charges may then appear on the customer's monthly bill or are directly charged to the customer's designated bank account or credit card. The wireless service provider 22 may also settle any charges with the mobile broadcast service provider 12 based on their contract.

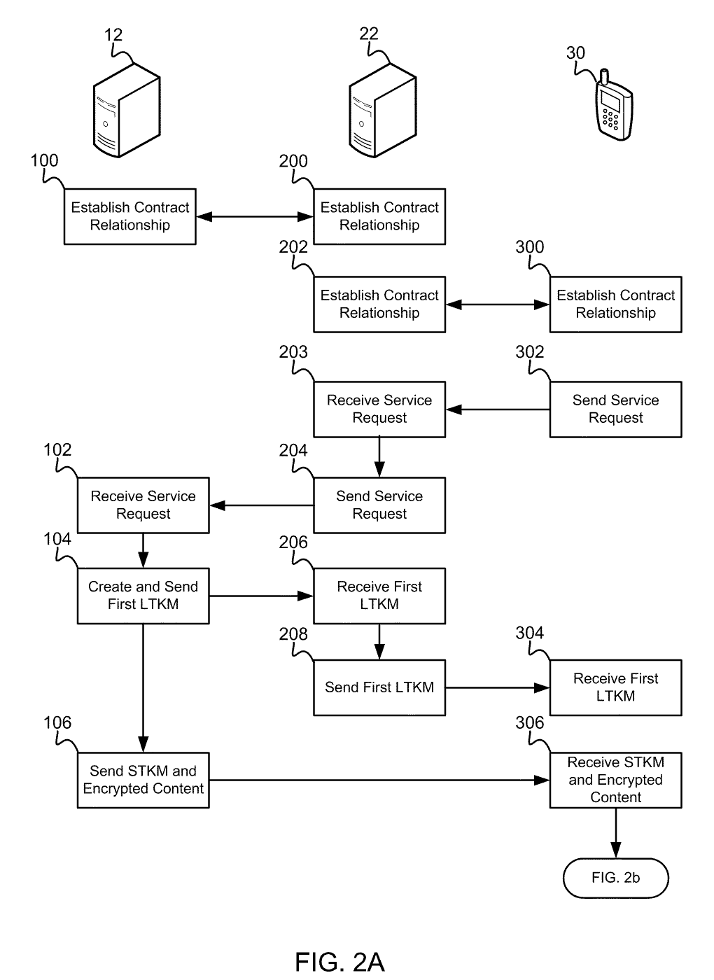

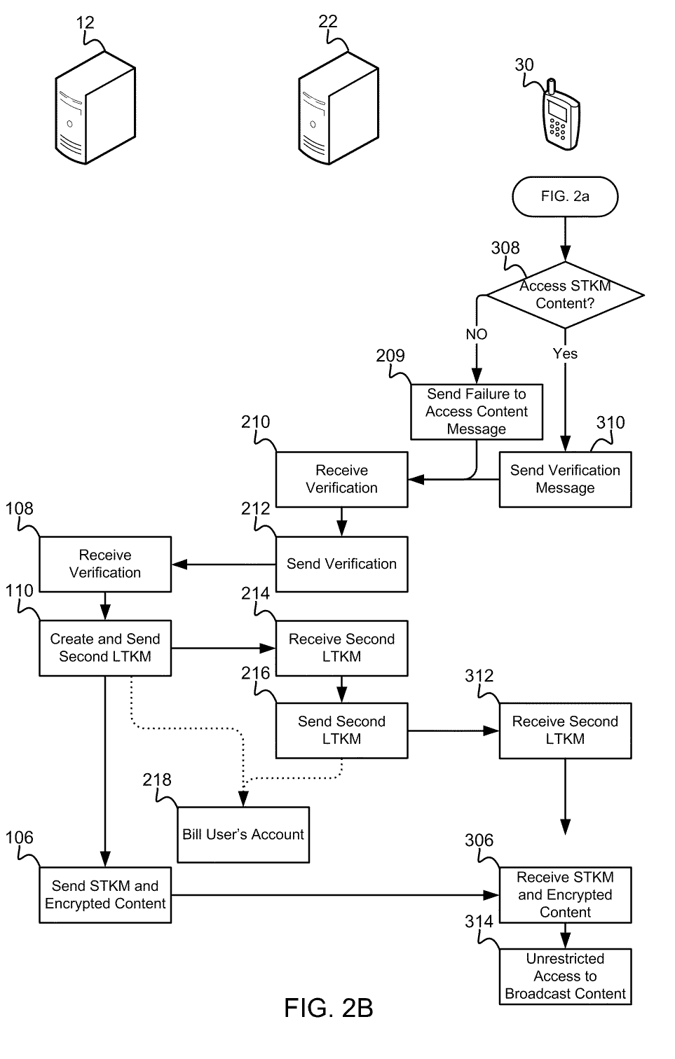

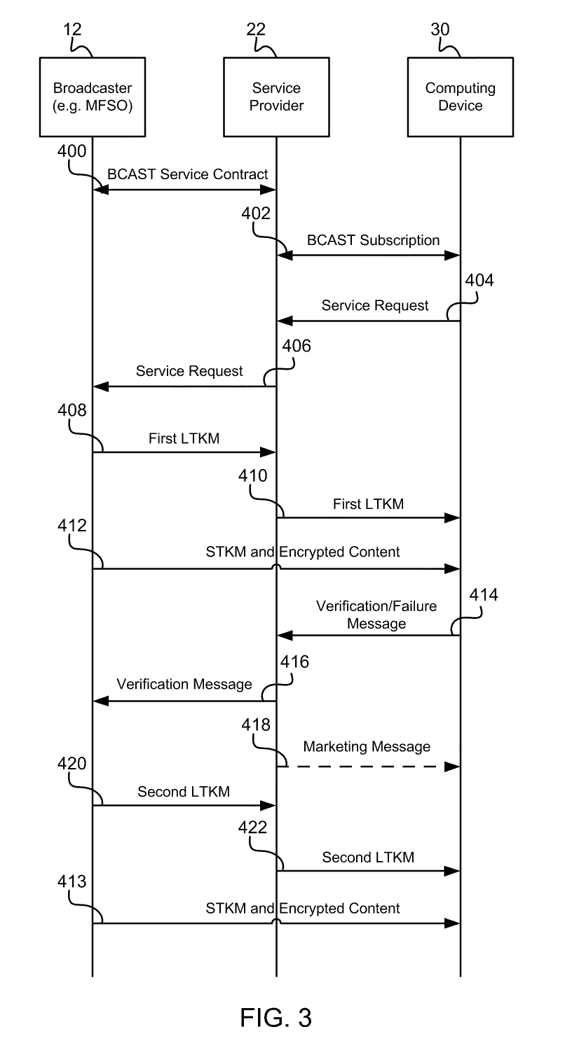

FIGS. 2A and 2B illustrate a method for verifying successful broadcast transmissions to mobile devices 30. FIG. 3 is a message flow diagram useful for describing the method shown in FIGS. 2A and 2B.

To provide mobile TV broadcast services to their customers, wireless service providers 22 may establish contract relationships with a mobile broadcast service provider 12, steps 100, 200, message 400. Each wireless service provider 22 may also establish contract relationships with mobile device 30 users in the form of subscriptions, for example, steps 202, 300, message 402. Alternatively, mobile TV broadcast service providers 12 may contract with cellular wireless service providers 22 to obtain unicast communication services to and from mobile devices 30 of their customers. Once the appropriate contracts are established, a mobile device 30 user may view or order programs on the mobile TV broadcast network 10 by sending a service request message via the wireless service provider 22, step 302, message 404. A broadcast service request message may include data which may indicate the user's order specifications, such as the particular program being requested.

Upon receiving the service request message from the mobile device 30, step 203, the wireless service provider 22 may relay the broadcast service request message to the mobile TV broadcast service provider 12, step 204, message 406. The mobile TV broadcast service provider 102 may receive the service request message, step 102, and based on the request specifications, create and send a first long term decryption key message, such as a first LTKM, for the use by the user's mobile device 30 to the wireless service provider, step 104, message 408. This first LTKM may include the terms and conditions under which the mobile device 30 can decrypt TEKs within STKMs to display the content of the requested program. The first LTKM transmitted to the wireless service provider 22 may also include restricted access keys to limit the user's ability to view the broadcast program. The first LTKM is transmitted using the unicast network 20 provided by the cellular wireless service provider 22.

Throughout the entire method, the mobile broadcast service provider 12 continually broadcasts a sequence of STKMs as well as encrypted broadcast content, step 106, messages 412 and 413.

The wireless service provider 22 may receive and send the first LTKM with the restricted access key to the user's mobile device 30, steps 206, 208, message 410. The mobile device 30 receives the first LTKM via the unicast network 20, step 304. The mobile device 30 also receives the STKM streams and encrypted content streams via the broadcast network 10, step 306. The mobile device 30 may use the first LTKM restricted access key to decrypt the TEK included in the STKM stream. The TEK is then used to decrypt the broadcasted content. The first LTKM may include terms and conditions to define access restrictions for the broadcast content streams, such as allowing the mobile device 30 to display the broadcast content for a short period of time, such two minutes, to enable the user to verify that the broadcast can be received. This may be done, for example, by limiting the number of TEKs that are decrypted using the LTKM restrict access key, such as permitting decryption of enough TEKs to enable two minute's worth of viewing time.

After the restricted access key expires a prompt may displayed on the mobile device display requesting the user to answer whether the requested program can be viewed satisfactorily on the mobile device 30. This prompt may be displayed using the graphical user interface of the mobile device 30. For example, a prompt may ask the user a question such as “Can You View the Program?” and give the user the options of answering “Yes” or “No.” A user may use a button press or activation of a pointing device, such as a finger press on a touchscreen display, to select an appropriate answer to the question. The mobile device 30 may determine whether the user's answer is affirmative (indicating that the program could be viewed satisfactorily) or negative (indicating that the program could not be viewed satisfactorily), step 308. If the user response indicates that the program could not be viewed satisfactorily, the mobile device 30 may format and send an unsatisfactory reception verification message, step 209, message 414. The unsatisfactory reception verification message is received by the wireless service provider 22, step 210, and relayed to the mobile TV broadcast service provider 12, step 212, message 416.

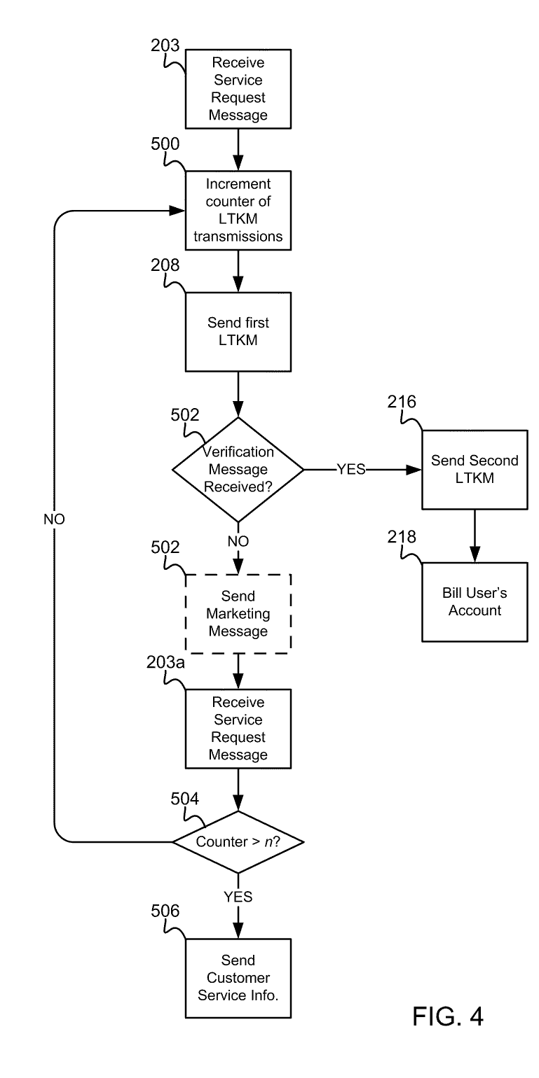

If the user fails to respond to the prompt, the mobile device 30 may not send any messages (i.e. neither a verification message nor a failure to access content message) to the wireless service provider 22. If an unsatisfactory reception verification message or no response from the mobile device 30 is received by the mobile TV broadcast service provider 12, the user's account should be billed for the requested program. In such circumstances, the mobile TV broadcast service provider may take additional actions such as those described in more detail below with reference to FIG. 4.

If the user selects the answer “Yes” in response to the prompt regarding reception of the sample program, thereby confirming that the user accessed the broadcasted content successfully (i.e., determination 308=“YES”), the mobile device 30 may create and send a satisfactory reception verification message via the wireless service provider 22, step 310, message 414. The wireless service provider 22 may receive the verification message, step 210, and transmit it to the mobile TV broadcast service provider 12, step 212, message 416. Upon receiving the verification message, step 108, the mobile TV broadcast service provider 12 may create and send a second LTKM to the wireless service provider 22, step 110, message 120, for relay to the mobile device 30 user, step 216, message 422. The second LTKM, which is received by the mobile device 30, step 312, may include a longer term or unrestricted access key which enables the user's mobile device 30 to decrypt the TEKs within the STKM streams corresponding to the selected program sent at step 106 and received at step 306, messages 412 and 413. The mobile device 30 then uses the decrypted TEKs to decrypt the requested broadcast content stream, step 314. The mobile TV broadcast service provider 12 continues broadcasting the STKM streams and encrypted content streams, step 106, which may be received by the mobile device 30, step 306. After transmitting the second LTKM and based on the user's verification message indicating that the user has received and accessed the broadcast content, the wireless service provider 22 or the mobile TV broadcast service provider 12 may bill the user's account for the price of the purchased broadcast content, step 218.

In an alternative embodiment, instead of transmitting a second LTKM including new terms and conditions and a new access key, the mobile TV broadcast service provider 12 may transmit a message configured to amend the restricted access key sent in the first LTKM. Such a message may include commands or code which causes the receiving mobile device to convert the restricted access key within the first LTKM to an unrestricted access key or a restricted access key with a longer life time. The converted access key may then be used to decrypt the TEKs in the STKMs and use those TEKs to decrypt the broadcast content streams to access the requested program.

In some circumstances a verification response message from the mobile device 30 may not be received via the mobile TV broadcast service provider 12. This may occur, for example, when the mobile device 30 is out of signal range or the user simply fails to respond to the prompt. When a verification message is not received by the mobile TV broadcast service providers after a period of time or when an unsatisfactory reception verification message is transmitted, the user may be sent an optional marketing message 418 inviting the user to repeat the request for purchase. The period of time that must elapse before the mobile TV broadcast service provider determines that the broadcast transmission was not received by a user's mobile device 30 may vary and may depend on the policies of each provider or preferences of each user. For example, such a period of time may be two minutes, five minutes or 20 minutes.

Allowing customers to repeatedly request and receive restricted access keys to briefly decrypt broadcast content could lead to abuse of the system. Unscrupulous customers might try to take advantage of the system by continually requesting service and pretending that their mobile devices 30 have failed to receive or display the broadcast contents. By repeatedly requesting LTKMs with restricted access keys, customers could view the broadcast contents in short samples. For certain contents or programs, such as broadcasts of live sporting events, a user may be able to view the entire sporting being broadcast by continually transmitting service request messages and using received first LTKM including restricted access keys to view the event bit by bit (e.g. two minutes at time) for free.

To prevent such misuse, the various embodiment methods and systems may provide a limit on the number of times a user may send service request for a program. For example, a limit of five (5) requests may be placed on sporting events which are more than one hour long, such as baseball games. A limit of two (2) requests may be placed on sporting events which may end quickly, such as certain boxing matches. If a customer cannot confirm access to the broadcast content within the allotted number of attempts (n) designated for a program, no further first LTKMs with restricted access keys may be transmitted to the user. After a user has exhausted his/her limited number of attempts to establish access, the mobile broadcast service provider may invite the user, by a marketing message, to contact the customer service to rectify any reception problems.

To limit unsuccessful access attempts a mobile TV broadcast service provider may implement a process such as the example embodiment illustrated in FIG. 4. In response to receiving a service request message, step 203, the mobile TV broadcast service provider may increment a counter of LTKM transmissions, step 500. The first time a first LTKM is transmitted, the counter will thus equal 1. The mobile TV broadcast service provider may then transmit the first LTKM as described above with reference to FIG. 2A, step 208. At this point, the mobile TV broadcast service provider may begin a timer to determine whether the verification message is received within a predetermined time, determination 502. If a satisfactory reception verification message is received before the timer expires (i.e., determination 502=“YES”), the mobile TV broadcast service provider may send the second LTKM, step 216, and bill the customer's account, step 218, as described above with reference to FIG. 2.

If the time for receiving the verification message expires without reception of any such message (i.e., determination 502=“NO”), the mobile TV broadcast service provider may send a marketing message to the mobile device, step 502. That marketing message may inform the mobile device user that an attempt was made to respond to the user's service request but the user failed to confirm satisfactory reception. The marketing message may also prompt the user to repeat the request for service, as well as take steps to ensure reception, such as moving to an area of better service coverage. Thereafter, the user may send another request for service message which the TV broadcast service provider may receive, step 203a. In this event, the mobile TV broadcast service provider may determine whether the counter of LTKM transmissions exceeds a maximum value (n), determination 504. Tracking the number of first LTKM transmissions may enable the mobile TV broadcast service provider to thwart attempts by users to view a program by sequentially requesting the program in order to view sample transmissions without purchasing the entire program. If the counter of first LTKM transmissions does not exceed the maximum value (n) (i.e., determination 504=“NO”), the mobile TV broadcast service provider may increment the counter, step 500, and resend a first LTKM with a return to step 208. However, if the counter of first LTKM transmissions exceeds the maximum value (n) (i.e., determination 504=“YES”), the mobile TV broadcast service provider may send another customer service message, step 506. This second customer service message may inform the customer that the number of requests to receive the program has been exceeded. In this manner, a mobile TV broadcast service provider can detect and defeat an attempt by an unscrupulous customer to bypass the pay-per-view process.

In an alternative embodiment not illustrated, instead of setting a limit on the number of times a user may request access to a broadcast program without paying for it as described above, mobile TV broadcast service providers may configure their server processors with software instructions to record and resend only one designated portion of a program every time a request for service is received. For example, the first two minutes of a live baseball game may be recorded and broadcasted along with an STKM stream to be used solely for verifying pay-per-view reception. In this embodiment, the TEK that is decrypted by the first LTKM restricted access key may only allow access to the short pre-recorded broadcast stream that is transmitted continuously in a loop. By allowing access to the same two minutes of a baseball game, an unscrupulous user cannot circumvent the system by repeatedly requesting service under the pretext that the broadcast transmission could not be received.

In another alternative embodiment not illustrated, a first LTKM for a multimedia clip (e.g., an advertisement) may be transmitted to the mobile device 30 in response to receiving a service request message for a broadcast program. Such a first LTKM would enable decryption and reception of the multimedia clip that is transmitted continuously in a loop along with corresponding STKMs containing TEKs that can be decoded by a key in the first LTKM. This multimedia clip may be a movie trailer, for example, or an advertisement for goods or services related or unrelated to the broadcast content requested by the user. This multimedia clip may be used to determine whether the requesting mobile device 30 can successfully receive pay-per-view broadcast transmissions. While the multimedia clip is playing or when it ends, a prompt may be displayed asking the user to verify reception. In this embodiment, this prompt may be included as part of the multimedia clip.

For example, a user may send a service request message for purchasing a soccer match program. The mobile TV broadcast service providers may then receive the request and send the user's mobile device 30 a first LTKM with a restricted access key and broadcast the STKM streams and encrypted content streams. The content streams may include the soccer match program and a prerecorded advertisement for a shampoo, for example. Upon receipt of the first LTKM and STKM stream, the user's mobile device may decrypt the TEK in the STKM stream which enables the mobile device to decrypt and access only the shampoo advertisement portion of the broadcast. While the advertisement is playing or after it is finished, a prompt may be displayed requesting the user to verify reception of the broadcast. If the user verifies reception, a second LTKM unrestricted access key may be transmitted to the user's mobile device which may be used to decrypt TEKs that allow access to the soccer match program. However, if the user does not verify reception of the broadcast or sends a reception failure verification message, the mobile TV broadcast service provider may either resend the first LTKM and prompt the user again to verify reception of the broadcast, or send a marketing message inviting the user to resend the service request message or call customer service. In this manner the user may be provided unlimited opportunities to purchase a desired broadcast by sending service request messages without the danger of abuse.

In an alternative embodiment not illustrated, after a user sends a service request for a broadcast content, the mobile device 30 may receive a first LTKM including a restricted access key and STKM and content streams. Based on the first LTKM restricted access key, the mobile device 30 may determine whether the encrypted content streams can be decrypted and displayed to the user. Upon such determination, the mobile device 30 may automatically send a verification response to the mobile TV broadcast service provider. In such an embodiment, the users may not be involved in the verification process. Accordingly, if the mobile TV broadcast service provider receives a verification message, the second LTKM including unrestricted access keys may be sent to the user's mobile device 30 to allow the user to view an ordered broadcast content. However, if a verification message is not received within a period of time, or if an unsatisfactory reception verification message is received by the mobile TV broadcast service providers, a marketing message may be transmitted to the mobile device 30 to inform the user that the requested broadcast cannot be received by the mobile device and therefore the user's account will not be billed.

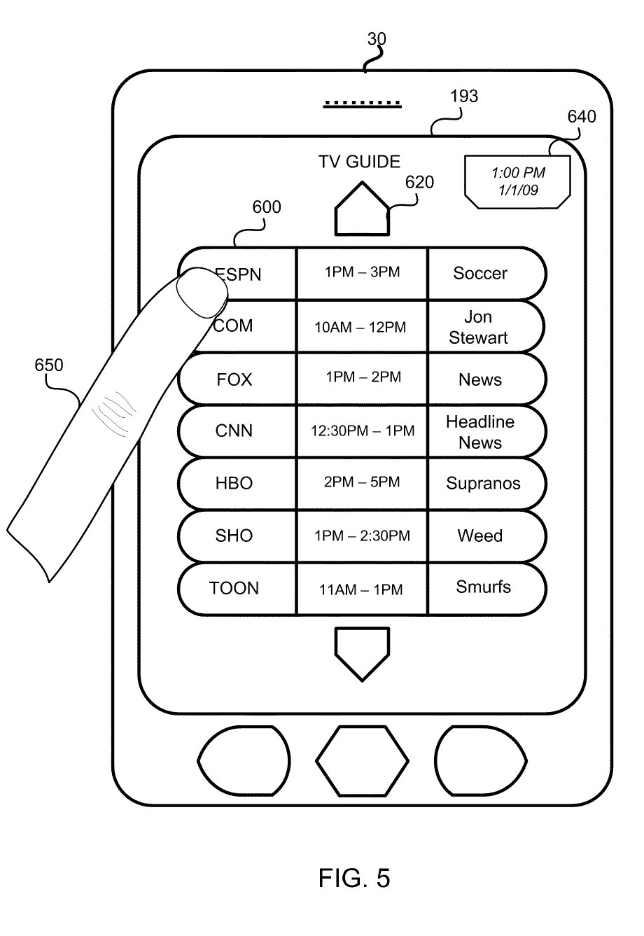

FIG. 5 is a front view of a mobile device 30 equipped with a touchscreen user interface illustrating a user ordering a mobile TV broadcast program on a menu or viewing guide (TV Guide) display of available broadcast TV programs. The broadcast TV programs may be displayed on the mobile device 30 display 193 using a graphical user interface (GUI). The TV Guide may include information about each program, such as the name of the content provider, name of the program and the time the program is scheduled to air. For example, the display on the mobile device 30, row 600 of the TV Guide informs the user that on Jan. 1, 2009 the ESPN channel is broadcasting a soccer match from 10 AM to 12 PM. The user may use a pointing device to select and purchase a desired program. For example, in mobile devices 30 equipped with a touchscreen 193, a user may use a finger 650 to select the desired program by touching the associated displayed icon. For example, FIG. 5 illustrates a user placing an order for the soccer match on the ESPN channel by touching the display using a finger 650. Additional features may be included in the graphical user interface to enable navigation through the TV Guide screen. For example, the graphical user interface may include arrows 620 to enable scrolling through a list of channels and programs. A date and time indicator 640 may also be displayed to allow the user to determine the current time and date when choosing different programs.

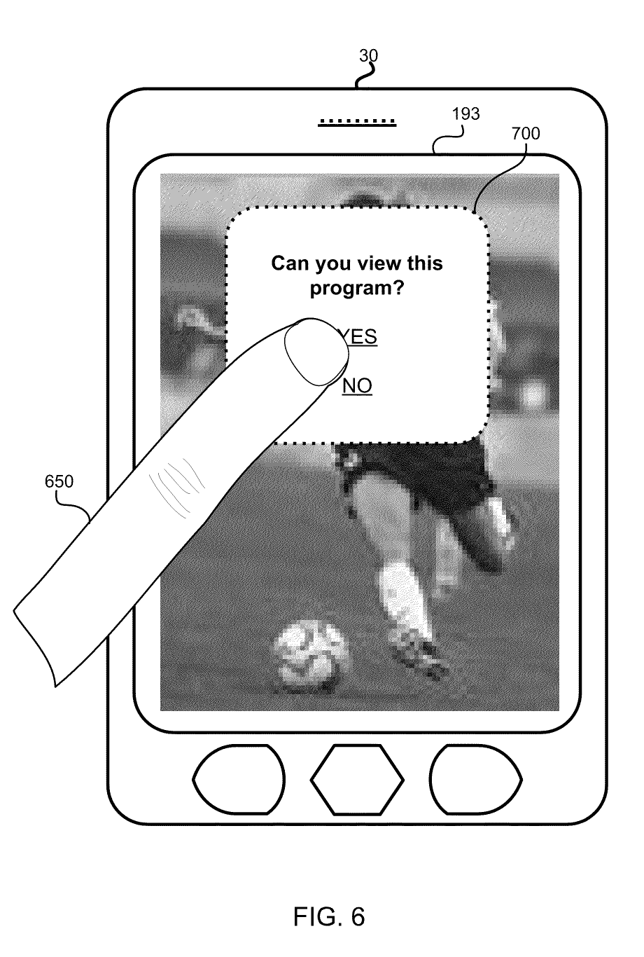

FIG. 6 is a front view of a mobile device 30 equipped with a touchscreen user interface illustrating a prompt requesting the user to verify satisfactory reception of the requested mobile TV broadcast program. As illustrated in FIG. 6, once the user selects a desired program, the mobile device 30 may receive a first LTKM that provides it access to the requested program. FIG. 6 illustrates the mobile device 30 displaying the requested soccer match program along with a prompt 700 requesting the user to verify reception of the program. The user may confirm reception, indicate that the program cannot be viewed, or not respond to the request for verification. If the user verifies reception of the broadcast by selecting “YES” on the prompt 700, the mobile device 30 may send a satisfactory reception verification message to the mobile TV broadcast service provider. The user may select “NO” from the prompt 700 when the user is unable to view the program, such as when the picture displayed by the mobile device 30 is unclear or if the program is not displayed. In such a scenario, the mobile device 30 may create and send an unsatisfactory reception verification message indicating that the user is experiencing difficulty viewing the soccer match program.

If the user's mobile device 30 does not receive the LTKM transmission and/or the STKM and content stream broadcasts, the user may not see the prompt 700, in which case no response will be sent to the mobile TV broadcast service provider.

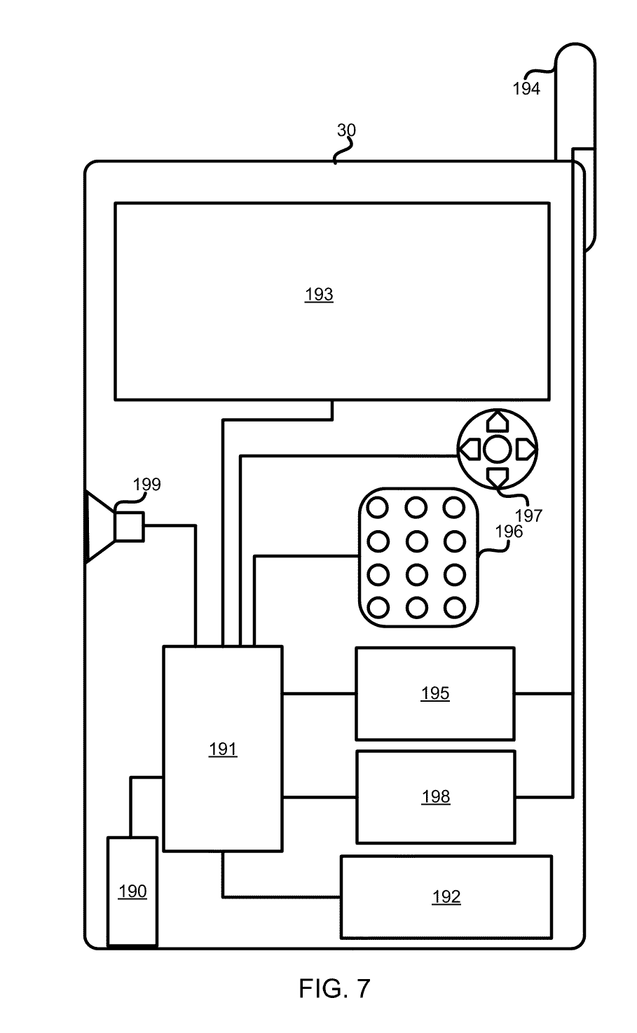

Typical mobile devices 30 suitable for use with the various embodiments will have in common the components illustrated in FIG. 7. For example, an exemplary mobile device 30 may include a processor 191 coupled to internal memory 192, a display 193, and to a speaker 199. Additionally, the mobile device 30 may have an antenna 194 for sending and receiving electromagnetic radiation that is connected to a wireless data link and/or cellular telephone transceiver 195 coupled to the processor 191. In some implementations, the transceiver 195 and portions of the processor 191 and memory 192 used for cellular telephone communications are collectively referred to as the air interface since it provides a data interface via a wireless data link. Mobile devices 30 typically also include a key pad 196 and/or miniature keyboard and menu selection buttons or rocker switches 197 for receiving user inputs.

The mobile device 30 may further include a mobile broadcast receiver 198 coupled to the antenna and to the processor 191. The mobile broadcast receiver 198 may be configured to receive mobile TV broadcasts and provide the received information to the processor 191 in a format that enables the processor 191 to display the mobile TV programs on the display 193 and speaker 199. The mobile broadcast receiver 198 may include circuitry for decrypting encrypted broadcast content, or may provide the encrypted broadcast content to the processor 191 for decryption.

The processor 191 may be any programmable microprocessor, microcomputer or multiple processor chip or chips that can be configured by software instructions (applications) to perform a variety of functions, including the functions of the various embodiments described herein. In some mobile devices 30, multiple processors 191 may be provided, such as one processor dedicated to wireless communication functions and one processor dedicated to running other applications. Typically, software applications may be stored in the internal memory 192 before they are accessed and loaded into the processor 191. In some mobile devices 30, the secure memory may be in a removable memory 190 coupled to the processor 191. In many mobile devices 30, the internal memory 192 may be a volatile or nonvolatile memory, such as flash memory, or a mixture of both. For the purposes of this description, a general reference to memory refers to all memory accessible by the processor 191, including internal memory 192, the memory chip 198, removable memory 190, and memory within the processor 191 itself.

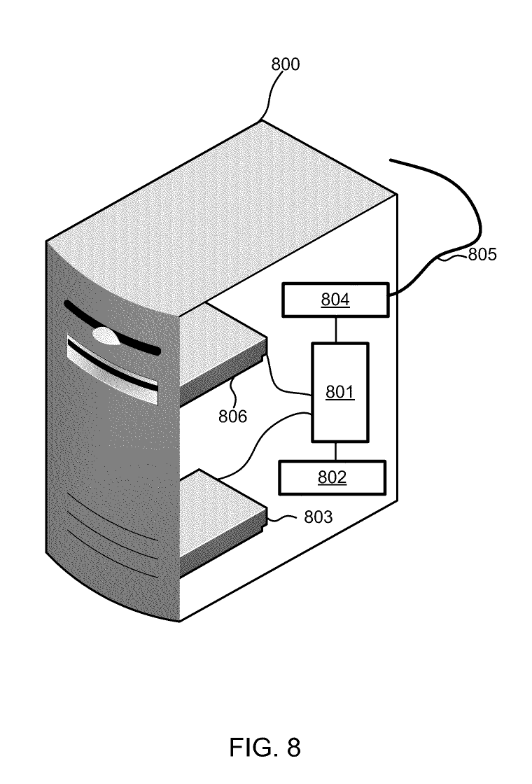

A number of the aspects described above may also be implemented with any of a variety of remote server devices, such as the server 800 illustrated in FIG. 8. Such a server 800 typically includes a processor 801 coupled to volatile memory 802 and a large capacity nonvolatile memory, such as a disk drive 803. The server 210 may also include a floppy disc drive and/or a compact disc (CD) drive 806 coupled to the processor 801. The server 800 may also include a number of connector ports 804 coupled to the processor 801 for establishing data connections with network circuits 805.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for verifying receipt of broadcast transmissions sent to mobile devices, comprising:
receiving a broadcast service request message from a mobile device requesting access to a broadcast program;
transmitting a first long term decryption key message to the mobile device, the first long term decryption key message including a restricted access key enabling the mobile device to access an encrypted broadcast content stream for a restricted period of time;
receiving a reception verification message from the mobile device; and
transmitting a second long term decryption key message to the mobile device enabling the mobile device to access the requested broadcast program when the received reception verification indicates that the encrypted broadcast content stream was satisfactorily received by the mobile device.

2. The method of claim 1, further comprising billing an account associated with the mobile device when the received reception verification indicates that the encrypted broadcast content stream was satisfactorily received by the mobile device.

3. The method of claim 1, further comprising:
transmitting a message to the mobile device when the received reception verification indicates that the encrypted broadcast content stream was not satisfactorily received by the mobile device.

4. The method of claim 1, wherein the first long term decryption key message is configured to cause the mobile device to display a prompt requesting a user to verify reception of a broadcast program.

5. The method of claim 2, wherein the first long term decryption key message enables the mobile device to access the requested broadcast program for a limited duration of time.

6. The method of claim 1, wherein the first long term decryption key message enables the mobile device to access another program.

7. The method of claim 1, further comprising:
counting received broadcast service request messages from the mobile device for the same requested broadcast program; and
comparing the count of received broadcast service request messages to a predetermined value,
wherein transmitting the first long term decryption key message to the mobile device occurs so long as the count does not exceed the predetermined value.

8. The method of claim 1, wherein the first long term decryption key message is a long term key message (LTKM).

9. A method for receiving a mobile broadcast in a mobile device, comprising:
transmitting a broadcast service request message to a mobile TV broadcast service provider requesting access to a broadcast program;
receiving a first long term decryption key message;
using a decryption key within the first long term decryption key message to decrypt an encrypted broadcast content stream;
displaying the decrypted broadcast content stream on a display of the mobile device;
displaying a prompt requesting a user to verify satisfactory reception of the decrypted broadcast content stream;
receiving an input from the user in response to the prompt;
generating a reception verification message based upon the received input from the user; and
transmitting the reception verification message to the mobile TV broadcast service provider.

10. The method of claim 9, further comprising:
receiving a second long term decryption key message;
using a decryption key within the second long term decryption key message to decrypt the requested broadcast program; and
displaying the requested broadcast program on the display of the mobile device.

11. The method of claim 9, wherein displaying a prompt requesting a user to verify satisfactory reception of the decrypted broadcast content stream comprises:
determining whether the first long term decryption key message includes a restricted access key; and
generating a prompt on the display when it is determined that the first long term decryption key message includes a restricted access key.

12. The method of claim 9, wherein displaying a prompt requesting a user to verify satisfactory reception of the decrypted broadcast content stream comprises:
obtaining an instruction from the first long term decryption key message; and
generating a prompt on the display based upon the obtained instruction.

13. The method of claim 9, further comprising:
generating a satisfactory reception verification message when the received input from the user indicates the decrypted broadcast content stream is satisfactorily displayed on the display of the mobile device.

14. The method of claim 9, further comprising:
generating an unsatisfactory reception verification message when the received input from the user indicates the decrypted broadcast content stream is not satisfactorily displayed on the display of the mobile device.

15. A mobile TV broadcast system, comprising:
a mobile TV broadcast network; and
a server coupled to the mobile TV broadcast network, the server configured to send messages to and receive messages from mobile devices via a unicast network;
wherein the server is configured with executable software instructions to perform steps comprising:
receiving a broadcast service request message from a mobile device requesting access to a broadcast program;
transmitting a first long term decryption key message to the mobile device, the first long term decryption key message including a restricted access key enabling the mobile device to access an encrypted broadcast content stream for a restricted period of time;
receiving a reception verification message from the mobile device; and
transmitting a second long term decryption key message to the mobile device enabling the mobile device to access the requested broadcast program when the received reception verification indicates that the encrypted broadcast content stream was satisfactorily received by the mobile device.

16. The mobile TV broadcast system of claim 15, wherein the server is configured with executable instructions to perform further steps comprising billing an account associated with the mobile device when the received reception verification indicates that the encrypted broadcast content stream was satisfactorily received by the mobile device.

17. The mobile TV broadcast system of claim 15, wherein the server is configured with executable instructions to perform further steps comprising:
transmitting a message to the mobile device when the received reception verification indicates that the encrypted broadcast content stream was not satisfactorily received by the mobile device.

18. The mobile TV broadcast system of claim 15, wherein the server is configured with executable instructions such that the first long term decryption key message is configured to cause the mobile device to display a prompt requesting a user to verify reception of a broadcast program.

19. The mobile TV broadcast system of claim 15, wherein the server is configured with executable instructions such that the first long term decryption key message enables the mobile device to access the requested broadcast program for a limited duration of time.

20. The mobile TV broadcast system of claim 15, wherein the server is configured with executable instructions such that the first long term decryption key message enables the mobile device to access another program.

21. The mobile TV broadcast system of claim 15, wherein the server is configured with executable instructions to perform further steps comprising:
counting received broadcast service request messages from the mobile device for the same requested broadcast program; and
comparing the count of received broadcast service request messages to a predetermined value,
wherein transmitting the first long term decryption key message to the mobile device occurs so long as the count does not exceed the predetermined value.

22. The mobile TV broadcast system of claim 15, wherein the server is configured with executable instructions such that the first long term decryption key message is a long term key message (LTKM).

23. A mobile device configured to receive mobile broadcast TV services, comprising:
a processor;
a display coupled to the processor;
a mobile broadcast receiver coupled to the processor, the mobile broadcast receiver configured to receive mobile broadcast transmissions from a mobile broadcast service provider;
a cellular network transceiver coupled to the processor and configured to communicate with a unicast cellular network; and
a memory coupled to the processor,
wherein the processor is configured with processor-executable instructions to perform steps comprising:
transmitting a broadcast service request message to a mobile TV broadcast service provider requesting access to a broadcast program;
receiving a first long term decryption key message;
using a decryption key within the first long term decryption key message to decrypt an encrypted broadcast content stream;
displaying the decrypted broadcast content stream on the display;
displaying a prompt requesting a user to verify satisfactory reception of the decrypted broadcast content stream;
receiving an input from the user in response to the prompt;
generating a reception verification message based upon the received input from the user; and
transmitting the reception verification message to the mobile TV broadcast service provider.

24. The mobile device of claim 23, wherein the processor is configured with executable instructions to perform further steps comprising:
receiving a second long term decryption key message;
using a decryption key within the second long term decryption key message to decrypt the requested broadcast program; and
displaying the requested broadcast program on the display of the mobile device.

25. The mobile device of claim 23, wherein the processor is configured with executable instructions such that displaying a prompt requesting a user to verify satisfactory reception of the decrypted broadcast content stream comprises:
determining whether the first long term decryption key message includes a restricted access key; and
generating a prompt on the display when it is determined that the first long term decryption key message includes a restricted access key.

26. The mobile device of claim 23, wherein the processor is configured with executable instructions such that displaying a prompt requesting a user to verify satisfactory reception of the decrypted broadcast content stream comprises:
obtaining an instruction from the first long term decryption key message; and
generating a prompt on the display based upon the obtained instruction.

27. The mobile device of claim 23, wherein the processor is configured with executable instructions to perform further steps comprising:
generating a satisfactory reception verification message when the received input from the user indicates the decrypted broadcast content stream is satisfactorily displayed on the display of the mobile device.

28. The mobile device of claim 23, wherein the processor is configured with executable instructions to perform further steps comprising:
generating an unsatisfactory reception verification message when the received input from the user indicates the decrypted broadcast content stream is not satisfactorily displayed on the display of the mobile device.

29. A mobile TV broadcast system, comprising:
means for receiving a broadcast service request message from a mobile device requesting access to a broadcast program;
means for transmitting a first long term decryption key message to the mobile device, the first long term decryption key message including a restricted access key enabling the mobile device to access an encrypted broadcast content stream for a restricted period of time;
means for receiving a reception verification message from the mobile device; and
means for transmitting a second long term decryption key message to the mobile device enabling the mobile device to access the requested broadcast program when the received reception verification indicates that the encrypted broadcast content stream was satisfactorily received by the mobile device.

30. The mobile TV broadcast system of claim 29, further comprising:
means for billing an account associated with the mobile device when the received reception verification indicates that the encrypted broadcast content stream was satisfactorily received by the mobile device.

31. The mobile TV broadcast system of claim 29, further comprising:
means for transmitting a message to the mobile device when the received reception verification indicates that the encrypted broadcast content stream was not satisfactorily received by the mobile device.

32. The mobile TV broadcast system of claim 29, wherein means for transmitting a first long term decryption key comprises means for transmitting a first long term decryption key message configured to cause the mobile device to display a prompt requesting a user to verify reception of a broadcast program.

33. The mobile TV broadcast system of claim 29, wherein means for transmitting a first long term decryption key comprises means for transmitting a first long term decryption key message configured to enable the mobile device to access the requested broadcast program for a limited duration of time.

34. The mobile TV broadcast system of claim 29, wherein means for transmitting a first long term decryption key comprises means for transmitting a first long term decryption key message configured to enable the mobile device to access another program.

35. The mobile TV broadcast system of claim 29, further comprising:
means for counting received broadcast service request messages from the mobile device for the same requested broadcast program; and
means for comparing the count of received broadcast service request messages to a predetermined value,
wherein means for transmitting the first long term decryption key message to the mobile device comprises means for transmitting the first long term decryption key message to a mobile device so long as the count does not exceed the predetermined value.

36. The mobile TV broadcast system of claim 29, wherein means for transmitting a first long term decryption key comprises means for transmitting a long term key message (LTKM).

37. A mobile device, comprising:
means for transmitting a broadcast service request message to a mobile TV broadcast service provider requesting access to a broadcast program;
means for receiving a first long term decryption key message;
means for using a decryption key within the first long term decryption key message to decrypt an encrypted broadcast content stream;
means for displaying the decrypted broadcast content stream on a display of the mobile device;
means for displaying a prompt requesting a user to verify satisfactory reception of the decrypted broadcast content stream;
means for receiving an input from the user in response to the prompt;
means for generating a reception verification message based upon the received input from the user; and
means for transmitting the reception verification message to the mobile TV broadcast service provider.

38. The mobile device of claim 37, further comprising:
means for receiving a second long term decryption key message;
means for using a decryption key within the second long term decryption key message to decrypt the requested broadcast program; and
means for displaying the requested broadcast program on the display of the mobile device.

39. The mobile device of claim 37, wherein means for displaying a prompt requesting a user to verify satisfactory reception of the decrypted broadcast content stream comprises:
means for determining whether the first long term decryption key message includes a restricted access key; and
means for generating a prompt on the display when it is determined that the first long term decryption key message includes a restricted access key.

40. The mobile device of claim 37, wherein means for displaying a prompt requesting a user to verify satisfactory reception of the decrypted broadcast content stream comprises:
means for obtaining an instruction from the first long term decryption key message; and
means for generating a prompt on the display based upon the obtained instruction.

41. The mobile device of claim 37, further comprising:
means for generating a satisfactory reception verification message when the received input from the user indicates the decrypted broadcast content stream is satisfactorily displayed on the display of the mobile device.

42. The mobile device of claim 37, further comprising:
means for generating an unsatisfactory reception verification message when the received input from the user indicates the decrypted broadcast content stream is not satisfactorily displayed on the display of the mobile device.

43. A computer program product, comprising:
a computer-readable medium, comprising:
at least one instruction for receiving a broadcast service request message from a mobile device requesting access to a broadcast program;
at least one instruction for transmitting a first long term decryption key message to the mobile device, the first long term decryption key message including a restricted access key enabling the mobile device to access an encrypted broadcast content stream for a restricted period of time;
at least one instruction for receiving a reception verification message from the mobile device; and
at least one instruction for transmitting a second long term decryption key message to the mobile device enabling the mobile device to access the requested broadcast program when the received reception verification indicates that the encrypted broadcast content stream was satisfactorily received by the mobile device.

44. The computer program product of claim 43, wherein the computer-readable medium further comprises at least one instruction for billing an account associated with the mobile device when the received reception verification indicates that the encrypted broadcast content stream was satisfactorily received by the mobile device.

45. The computer program product of claim 43, wherein the computer-readable medium further comprises:
at least one instruction for transmitting a message to the mobile device when the received reception verification indicates that the encrypted broadcast content stream was not satisfactorily received by the mobile device.

46. The computer program product of claim 43, wherein the first long term decryption key message is configured to cause the mobile device to display a prompt requesting a user to verify reception of a broadcast program.

47. The computer program product of claim 43, wherein the first long term decryption key message enables the mobile device to access the requested broadcast program for a limited duration of time.

48. The computer program product of claim 43, wherein the first long term decryption key message enables the mobile device to access another program.

49. The computer program product of claim 43, wherein the computer-readable medium further comprises:
at least one instruction for counting received broadcast service request messages from the mobile device for the same requested broadcast program; and
at least one instruction for comparing the count of received broadcast service request messages to a predetermined value,
wherein transmitting the first long term decryption key message to the mobile device occurs so long as the count does not exceed the predetermined value.

50. The computer program product of claim 43, wherein the first long term decryption key message is a long term key message (LTKM).

51. A computer program product, comprising:
a computer-readable medium, comprising:
at least one instruction for transmitting a broadcast service request message to a mobile TV broadcast service provider requesting access to a broadcast program;
at least one instruction for receiving a first long term decryption key message;
at least one instruction for using a decryption key within the first long term decryption key message to decrypt an encrypted broadcast content stream;
at least one instruction for displaying the decrypted broadcast content stream on a display of the mobile device;
at least one instruction for displaying a prompt requesting a user to verify satisfactory reception of the decrypted broadcast content stream;
at least one instruction for receiving an input from the user in response to the prompt;
at least one instruction for generating a reception verification message based upon the received input from the user; and
at least one instruction for transmitting the reception verification message to the mobile TV broadcast service provider.

52. The computer program product of claim 51, wherein the computer-readable medium further comprises:
at least one instruction for receiving a second long term decryption key message;
at least one instruction for using a decryption key within the second long term decryption key message to decrypt the requested broadcast program; and
at least one instruction for displaying the requested broadcast program on the display of the mobile device.

53. The computer program product of claim 51, wherein the at least one instruction for displaying a prompt requesting a user to verify satisfactory reception of the decrypted broadcast content stream comprises:
at least one instruction for determining whether the first long term decryption key message includes a restricted access key; and
at least one instruction for generating a prompt on the display when it is determined that the first long term decryption key message includes a restricted access key.

54. The computer program product of claim 51, wherein the at least one instruction for displaying a prompt requesting a user to verify satisfactory reception of the decrypted broadcast content stream comprises:
at least one instruction for obtaining an instruction from the first long term decryption key message; and
at least one instruction for generating a prompt on the display based upon the obtained instruction.

55. The computer program product of claim 51, wherein the computer-readable medium further comprises:
at least one instruction for generating a satisfactory reception verification message when the received input from the user indicates the decrypted broadcast content stream is satisfactorily displayed on the display of the mobile device.

56. The computer program product of claim 51, wherein the computer-readable medium further comprises:
at least one instruction for generating an unsatisfactory reception verification message when the received input from the user indicates the decrypted broadcast content stream is not satisfactorily displayed on the display of the mobile device.
